(19) United States
(12) Patent Application Publication
(10) Pub. No.: US 2026/0138515 A1
(43) Pub. Date: May 21, 2026

(54) VEHICLE SEAT HEAD RESTRAINT ASSEMBLY

(71) Applicant: GM Global Technology Operations LLC, Detroit, MI (US)

(72) Inventors: Tomislav Radisic, Novi, MI (US); Sherin Lal G M, Nadu (IN); Edward Thaddeus Kuczynski, Ann Arbor, MI (US)

(21) Appl. No.: 18/952,131

(22) Filed: Nov. 19, 2024

(51) Int. Cl. B60N 2/80

(52) U.S. Cl. CPC B60N 2/80; B60N 2002/899

(57) ABSTRACT

A head restraint assembly of a vehicle seat defines a first axis, a second axis perpendicular to the first axis, and a third axis perpendicular to the first axis and the second axis and includes a head restraint structure defining a surface. The head restraint structure includes a main body comprising a foam material, and a cored portion comprising the foam material disposed on the surface, the cored portion comprising a plurality of recesses extending along the first axis and wall portions extending between the plurality of recesses.

The subject disclosure relates to vehicles, and in particular to a head restraint assembly for vehicle seats.

A vehicle seat generally includes a seat base, a seatback, and a head restraint which is sometimes referred to a headrest. The seat and the seatback support the occupant, while the head restraint may restrain the head of the occupant from rearward movement during sudden braking and/or accidents, as well as provide a structure for the occupant to rest the back of the head. Occupant comfort is important for vehicle seats. Accordingly, it is desirable to provide an improved head restraint assembly.

### SUMMARY

In one exemplary embodiment, a head restraint assembly of a vehicle seat defines a first axis, a second axis perpendicular to the first axis, and a third axis perpendicular to the first axis and the second axis and comprises a head restraint structure defining a surface. The head restraint structure comprises a main body comprising a foam material and a cored portion comprising the foam material disposed on the surface, the cored portion comprising a plurality of recesses extending along the first axis and wall portions extending between the plurality of recesses.

In addition to one or more of the features described herein, the plurality of recesses reduce a firmness of the cored portion to be less than a firmness of the main body.

In addition to one or more of the features described herein, the main body and the cored portion are formed together of molded foam.

In addition to one or more of the features described herein, the cored portion is formed separately from the main body and attached to an opening in the surface of the main body.

In addition to one or more of the features described herein, the plurality of recesses are arranged in a matrix with a plurality of rows of the plurality of recesses extending along the second axis and a plurality of columns of the plurality of recesses extending along the third axis.

In addition to one or more of the features described herein, the foam material is polyurethane foam or expanded polypropylene.

In addition to one or more of the features described herein, the rows of the plurality of recesses are alternatingly offset from each other.

In addition to one or more of the features described herein, the columns of the plurality of recesses are alternatingly offset from each other.

In addition to one or more of the features described herein, outermost recesses of the plurality of recesses very in width or diameter.

In addition to one or more of the features described herein, outermost columns of the rows of the plurality of recesses have a width or diameter along the second axis that is less than a width or diameter of the plurality of recesses that are on an inner side of the outermost columns of the plurality of recesses.

In addition to one or more of the features described herein, the plurality of recesses continuously reduce in size from innermost recesses of the plurality of recesses to the outermost recesses of the plurality of recesses.

In addition to one or more of the features described herein, each of the plurality of recesses is tapered such that an open end thereof is larger than a closed end thereof.

In addition to one or more of the features described herein, the head restraint assembly further comprises a support core structure around which the head restraint structure is disposed, and stems extending from the support core structure along the third axis.

In addition to one or more of the features described herein, each of the plurality of recesses is shaped as a rectangle or a partial rectangle when viewed along the first axis.

In addition to one or more of the features described herein, each of the plurality of recesses is shaped as a trapezoid or a partial trapezoid when viewed along the first axis.

In addition to one or more of the features described herein, each of the plurality of recesses is shaped as a diamond or a partial diamond when viewed along the first axis.

In addition to one or more of the features described herein, each of the plurality of recesses is shaped as an oval or a partial oval when viewed along the first axis.

In addition to one or more of the features described herein, the wall portions extend continuously between ends of the cored portion along the third axis in a zigzag pattern.

In another exemplary embodiment, a head restraint assembly of a vehicle seat comprises a head restraint structure, a support core structure around which the head restraint structure is disposed, and stems extending from the support core structure to a seatback. The head restrains structure defines a surface. The head restraint structure comprises a main body comprising a foam material comprising polyurethane foam or expanded polypropylene, and a cored portion comprising the foam material disposed on the surface, the cored portion comprising a plurality of recesses extending along the first axis and wall portions extending between the plurality of recesses. The plurality of recesses reduce a firmness of the cored portion to be less than a firmness of the main body. The main body and the cored portion are formed together of molded foam. The plurality of recesses are arranged so as to have a plurality of rows of the plurality of recesses and a plurality of columns of the plurality of recesses. The rows of the plurality of recesses or the columns of the plurality of recesses are alternatingly offset from each other. Outermost rows of the rows of the plurality of recesses and have a width or diameter that vary in width or diameter. Each of the plurality of recesses is tapered such that an open end thereof is larger than a closed end thereof. The wall portions extend continuously between ends of the cored portion in a zigzag pattern.

In yet another exemplary embodiment, a vehicle comprises a vehicle seat comprising a seatback and a head restraint assembly extending from the seatback. The head restraint assembly comprises a head restraint structure defining a surface. The head restraint structure comprises a main body comprising a foam material, and a cored portion comprising the foam material disposed on the surface, the cored portion comprising plurality of recesses extending into the surface and wall portions extending between the plurality of recesses.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a head restraint assembly according to a non-limiting example;

FIG. 2 is a front view of a head restraint assembly according to a non-limiting example;

FIG. 3A is a cross-sectional view of a head restraint assembly according to a non-limiting example taken at 3-3 of FIG. 2;

FIG. 3B is a cross-sectional view of a head restraint assembly according to a non-limiting example taken at 3-3 of FIG. 2;

FIG. 4 is a front view of a head restraint assembly according to a non-limiting example;

FIG. 5A is a front view of a head restraint structure according to a non-limiting example;

FIG. 5B is a front view of a head restraint structure according to a non-limiting example;

FIG. 5C is a front view of a head restraint structure according to a non-limiting example;

FIG. 5D is a front view of a head restraint structure according to a non-limiting example;

FIG. 5E is a front view of a head restraint structure according to a non-limiting example; and

FIG. 5F is a front view of a head restraint structure according to a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

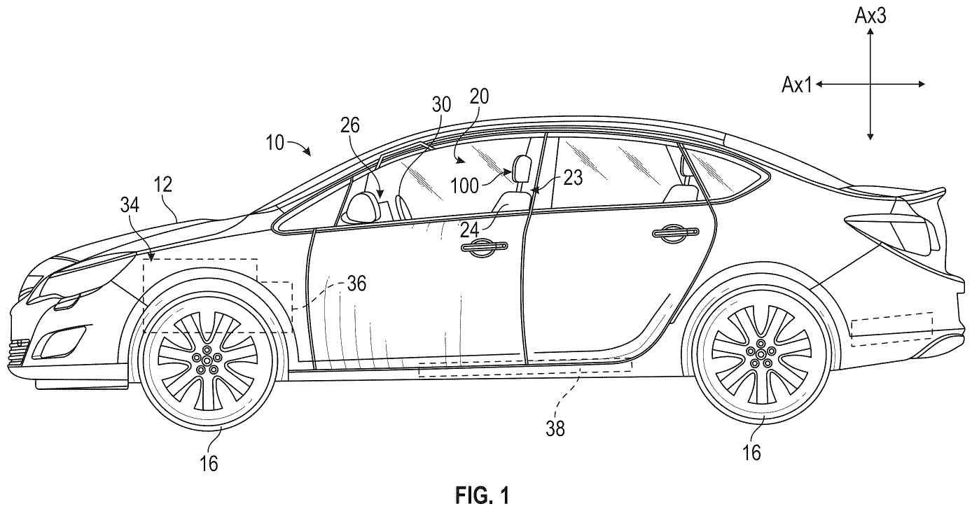

A vehicle 10 according to a non-limiting example is shown in FIG. 1. The vehicle 10 defines a first axis A×1, a second axis A×2 perpendicular to the first axis A×1, and a third axis A×3 perpendicular to the first axis A×1 and the second axis A×2. According to a non-limiting example, the first axis A×1 corresponds to a longitudinal axis of the vehicle 10, the second axis A×2 corresponds to a lateral axis of the vehicle 10, and the third axis A×3 corresponds to a vertical axis of the vehicle. The vehicle 10 includes a body 12 supported on a plurality of wheels 16. One or more of the plurality of wheels 16 are steerable. The body 12 defines, in part, a passenger compartment 20 having vehicle seats 23 positioned behind a dashboard 26. The vehicle seat 23 may include a seat base (not shown), a seatback 24, and a head restraint assembly 100. A steering control 30 is arranged between the vehicle seats 23 and the dashboard 26. The steering control 30 is operated to control orientation of the steerable wheel(s) 16.

The vehicle 10 includes a prime mover 34 connected to a gear assembly and/or transmission 36 that provides power to one or more of the plurality of wheels 16. The prime mover 34 may be an engine, a motor, a hybrid engine and motor system, or other prime movers known in the art. A rechargeable energy storage system (RESS) may be arranged in the body 12 and may provide power to components within the vehicle (e.g., the prime mover 34). As a non-limiting example, the rechargeable energy storage system may include a battery assembly 38. While specific locations are shown for the prime mover 34, the gear assembly and/or transmission 36, and the battery assembly 38 in FIG. 1, these locations are merely exemplary and not limiting, and locations of these structures may vary.

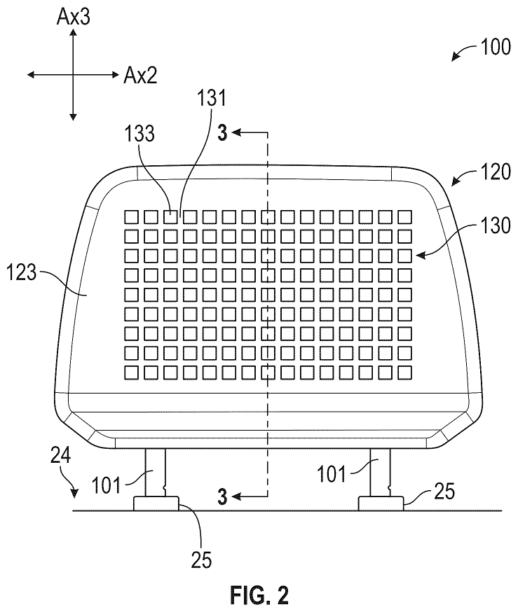

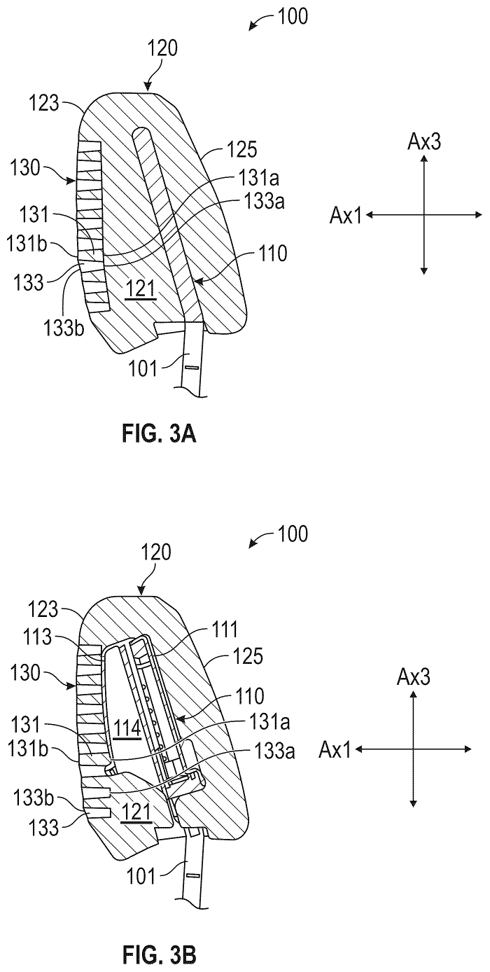

As shown in FIGS. 2, 3A, and 3B, the head restraint assembly 100 may include stems 101 extending substantially along the third axis A×3 from locking guide sleeves 25 disposed on the seatback 24 and terminating at a support core structure 110 disposed within a head restraint structure 120. According to one or more embodiments, the head restraint structure 120 may include or be formed of foam. As non-limiting examples, the head restraint structure 120 may include polyurethane foam or expanded polypropylene. As a non-limiting example, the head restraint assembly 100 may include two stems 101. The support core structure 110 may be coupled to each of the two stems 101. As non-limiting examples, the support core structure 110 may be a plate shaped structure. The stems 101 may extend upward generally along the third axis A×3 to a connecting rod (not shown) that extends along the second axis A×2 and connects upper ends of the stems 101 in another example. The head restraint structure 120 may extend between a front surface 123 and a rear surface 125. The front surface 123 faces a forward direction along the first axis A×1. The front surface 123 is configured to support and/or restrain the head of an occupant.

The head restraint structure 120 includes a main body 121 and a cored portion 130 at the front surface 123 of the head restraint structure 120. The cored portion 130 may include a plurality of recesses 133 that define wall portions 131 therebetween. That is, the wall portions 131 extend between the recesses 133 and are connected to each other to form part of the front surface 123. According to a non-limiting example, the wall portions 131 may be flush with portions of the front surface 123 surrounding the cored portion 130. The wall portions 131 may extend continuously between the portions of the front surface 123 surrounding the cored portion 130.

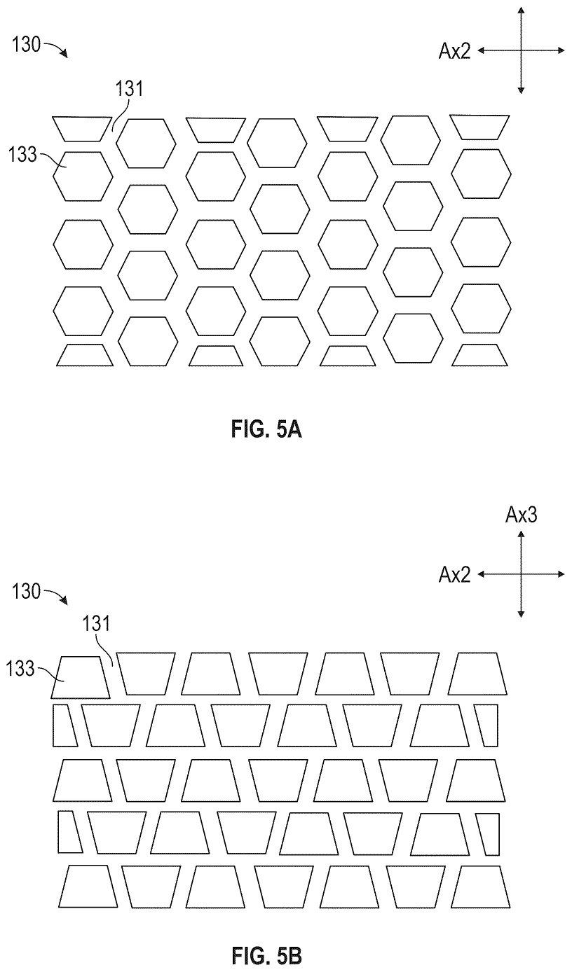

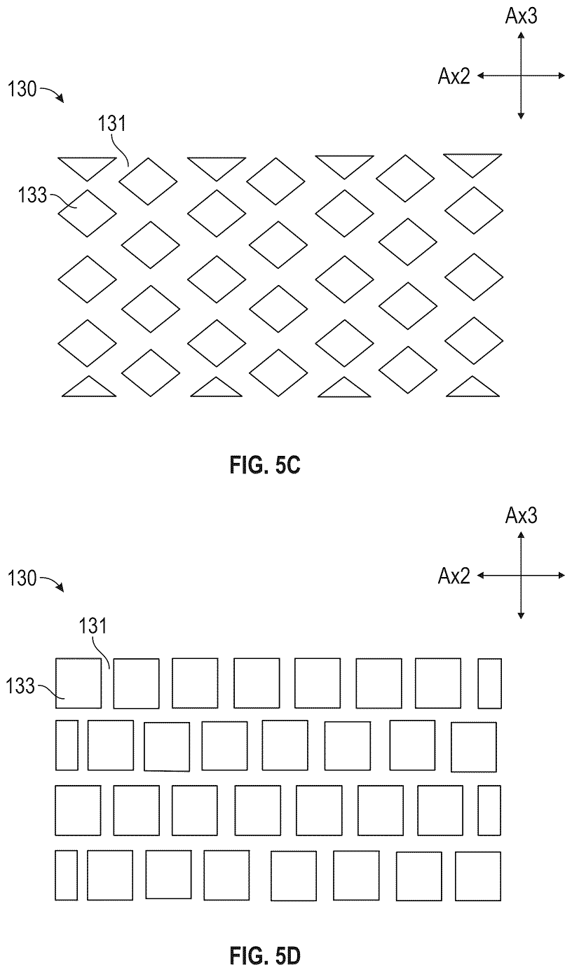

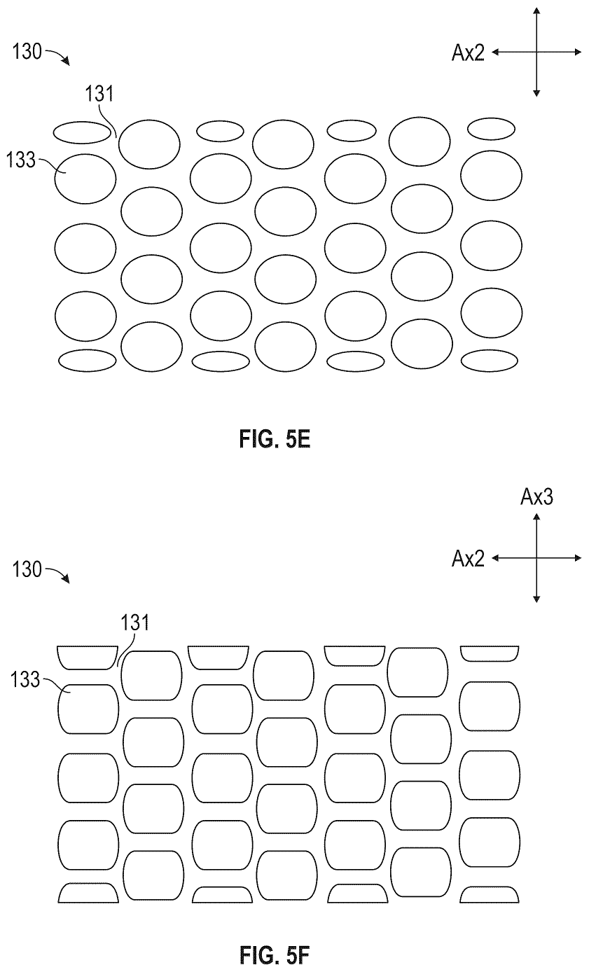

While FIG. 2 shows the cored portion as a waffle structure with a matrix of nine square-shaped recesses 133 along the third axis A×3 and fifteen square-shaped recesses 133 along the second axis A×2, the present application is not limited thereto. According to one or more embodiments, the cored portion 130 may have any number of recesses 133 along the third axis and any number of recesses 133 along the second axis A×2. According to one or more embodiments, the recesses 133 may have different shapes. Non-limiting examples of different shapes of the recesses 133 are shown in FIGS. 5A-5F. According to one or more embodiments, columns of the recesses 133 along the third axis A×3 may be offset from each other and/or rows of the recesses 133 may be offset from each other along the second axis A×2, non-limiting examples of which are shown in FIGS. 5A-5F.

As shown in FIG. 3A, each of the recesses 133 is structured as a blind via and extends from an open end 133b to a closed end 133a, and each of the wall portions 131 extends from a base 131a to a free end 131b. Each of the recesses 133 may be tapered such that a width or a diameter of each of the recesses 133 along the third axis A×3 and/or along the second axis A×2 decreases from the open end 133b to the closed end 133a. Each of the wall portions 131 may be tapered such that a width of each of the wall portions 131 along the third axis A×3 and/or along the second axis A×2 decreases from the base 131a to the free end 131b.

While FIG. 3A shows the support core structure 110 being a single structure around which the head restraint structure 120 is disposed, as shown in FIG. 3B, the support core structure 110 may include multiple structures. For example, the support core structure 110 may include a core body 111 and an elastic plate 113 that extends forward along the first axis A×1 from the core body 111 with a void 114 therebetween to allow the elastic plate 113 to move rearward along the first axis A×1 towards the core body 111. The void 114 may be empty or filled with a soft material that is softer than the head restraint structure 120.

According to an example, the base 131a of some of the wall portions 131 may abut the support core structure 110 (e.g., the elastic plate 113). According to an example, the closed end 133a may instead be an open end that is open to the support core structure 110 (e.g., the elastic plate 113) as shown in FIG. 3B, and the wall portions 131 that abut the support core structure 110 may be shorter along the first axis A×1 than the wall portions 131 that do not abut the support core structure 110. According to an example, the recesses 133 that are open to the support core structure 110 may be shallower along the first axis A×1 than the recesses 133 that are not open to the support core structure 110 as shown in FIG. 3B.

The recesses 133 may allow the cored portion 130 to be softer than the main body 121 without requiring different materials to provide more comfort to the occupant.

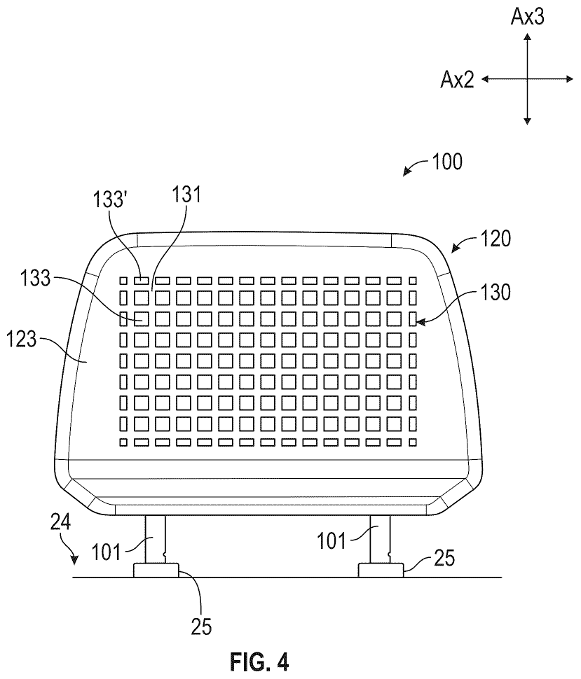

As shown in FIG. 4, according to one or more embodiments, outermost recesses 133′ at outermost positions of the cored portion 130 may have a width or diameter smaller than the remainder of the recesses 133. That is, the cored portion 130 may have a ring of recesses 133′ with varying widths. The outermost recesses 133′ allow the outer positions of the cored portion 130 to be softer than the main body 121, FIG. 3, but firmer than the inner positions of the cored portion 130 having the recesses 133, providing a transition between firnesses of the cored portion 130 and the main body 121. While FIG. 4 shows only a single ring of the outermost recesses 133′ that have reduced widths or diameters with respect to the recesses 133 on the inner positions thereof, according to one or more embodiments, the cored portion 130 may include two or more rings of outermost recesses 133′ with varying sizes. According to one or more embodiments, the size variations may be gradual from recesses 133 at an innermost position towards recesses 133′ at outermost positions of the front surface 123.

FIGS. 5A-5F show non-limiting examples of configurations of the cored portion 130. As shown in FIG. 5A, the recesses 133 may be hexagons or partial hexagons. According to one or more embodiments, alternating columns of the recesses 133 may be offset such that the wall portions 131 may form a honeycomb pattern. Alternatively or additionally, alternating rows of the recesses 133 may be offset.

As shown in FIG. 5B, the recesses 133 may be trapezoids or partial trapezoids. According to one or more embodiments, the recesses 133 may alternate in orientation along the second axis A×2 between a trapezoid with the longer side on the bottom and a trapezoid with the longer side on the top. Further, alternating rows of the recesses 133 may be offset. Alternatively or additionally, alternating columns of the recesses 133 may be offset.

As shown in FIG. 5C, the recesses 133 may be diamond or partial diamonds. According to one or more embodiments, alternating columns of the recesses 133 may be offset. Alternatively or additionally, alternating rows of the recesses 133 may be offset.

As shown in FIG. 5D, the recesses 133 may be rectangles (e.g., square) or partial rectangles (e.g., partial squares). According to one or more embodiments, alternating rows of the recesses 133 may be offset. Alternatively or additionally, alternating columns of the recesses 133 may be offset.

As shown in FIG. 5E, the recesses 133 may be ovals or partial ovals (not shown). Some of the recesses 133 on an outer ring of the recesses 133 may be smaller than other recesses. According to one or more embodiments, alternating columns of the recesses 133 may be offset. Alternatively or additionally, alternating rows of the recesses 133 may be offset.

As shown in FIG. 5F, the recesses 133 may be shaped to have two parallel sides connected by two curved sides, or a part thereof. According to one or more embodiments, alternating columns of the recesses 133 may be offset. Alternatively or additionally, alternating rows of the recesses 133 may be offset.

The embodiments shown in FIGS. 5A-5F show alternating rows and/or columns of the recesses being offset. As such, while the embodiment shown in FIG. 2 has wall portions 131 that extend linearly from ends of the cored portion 130 along the second axis A×2 and the third axis A×3, the wall portions 131 in the embodiments shown in FIGS. 5A-5F extend in a more zigzag pattern. The zigzag pattern may limit firm areas of the cored portion 130 (e.g., areas in FIG. 2 where the wall portions 131 extending along the second axis A×2 intersect with the wall portions 131 extending along the third axis A×3).

The cored portion 130 may be formed integrally with the main body 121. For example, the cored portion 130 may be formed by a die that includes protrusions shaped to correspond to the recesses 133 such that the head restraint structure 120 includes the main body 121 and the cored portion 130 that are integrally formed together. According to another non-limiting example, the recesses 133 may be formed by removing material from the head restraint structure 120 by boring and/or cutting. Alternatively, the cored portion 130 may be formed separately and inserted into an opening in the main body 121.

According to one or more embodiments, the recesses 133 may have a depth along the first axis A×1 in a range of 10 mm-30 mm, or in a range of 20 mm-25 mm. According to one or more embodiments, a surface area occupied by the recesses 133 in a plane defined by the second axis A×2 and the third axis A×3 may be in a range of 25%-75% of the surface area of the cored portion 130. According to one or more embodiments, a surface area occupied by the recesses 133 in a plane defined by the second axis A×2 and the third axis A×3 may be in a range of 40%-60% of the surface area of the cored portion 130.

According to one or more embodiments, a cover or a trim (now shown) may be disposed over the head restraint structure 120 such that the recesses 133 are not visible to the occupant. According to one or more embodiments, a maximum dimension of each recess 133 within a plane defined by the second axis A×2 and the third axis A×3 is 25 mm or less, as a maximum dimension hat exceeds 25 mm may show as depressions in the cover or the trim covering the head restraint structure 120.

According to one or more embodiments, the main body 121 of the head restraint structure 120 may include or be formed of molded foam having firmness in a range of 8 kPa to 16 kPa, or in a range of 8 kPa to 12 kPa. The cored portion 130 may include recesses 133 that reduce the volume of the molded foam, which effectively reduces an apparent foam firmness at the cored portion 130. The apparent foam firmness may be proportionately reduced to a factor determined by dividing a volume of the wall portions 131 to a volume of a sum of the wall portions 131 and the recesses 133. According to one or more embodiments, the factor may be within a range of 40% to 70%. According to one or more embodiments, the factor may be within a range of 50% to 60%.

According to one or more embodiments, the cored portion 130 has an apparent foam firmness in a range of 3.5 kPa to 6.0 kPa, measured as Compression Force Deflection (CFD) per ISO 3386-1 procedure. According to one or more embodiments, the cored portion 130 has an apparent foam firmness in a range of 3.5 kPA to 4.5 kPa. The cored portion 130 may form an enhanced occupant comfort interface.

According to one or more embodiments, the wall portions 131 may have a thickness in a range of 5 mm to 20 mm to provide sufficient wall integrity and avoid depressions in the cover or trim, while providing sufficient reduction in firmness.

The cored portion 130, according to one or more embodiments, provides stiffness for adequate cover or trim support while a reduction in firmness resulting from the recesses 133 provides occupant comfort. According to one or more embodiments, the head restraint structure 120 including the main body 121 and the cored portion 130 for enhanced comfort may be formed via a single foam mold in a single foam manufacturing cycle.

As a non-limiting example, the cored portion 130 may be formed separately from the main body 121 via a die-cut sheet of soft foam with pressure sensitive adhesive that attaches to an opening in the main body 121. As a non-limiting example, the cored portion 130 may be formed separately from the main body 121 via a soft comfort pad molded in a head restraint mold in one process cycle, and the main body 121 may be molded over the cored portion 130 in a second process cycle in the same mold.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A head restraint assembly of a vehicle seat defining a first axis, a second axis perpendicular to the first axis, and a third axis perpendicular to the first axis and the second axis, the head restraint assembly comprising:
a head restraint structure defining a surface and comprising:
a main body comprising a foam material, and
a cored portion comprising the foam material disposed on the surface, the cored portion comprising a plurality of recesses extending along the first axis and wall portions extending between the plurality of recesses.

2. The head restraint assembly of claim 1, wherein the plurality of recesses reduce a firmness of the cored portion to be less than a firmness of the main body.

3. The head restraint assembly of claim 1, wherein the main body and the cored portion are formed together of molded foam.

4. The head restraint assembly of claim 1, wherein the cored portion is formed separately from the main body and attached to an opening in the surface of the main body.

5. The head restraint assembly of claim 1, wherein the plurality of recesses are arranged in a matrix with a plurality of rows of the plurality of recesses extending along the second axis and a plurality of columns of the plurality of recesses extending along the third axis.

6. The head restraint assembly of claim 1, wherein the foam material is polyurethane foam or expanded polypropylene.

7. The head restraint assembly of claim 5, wherein the rows of the plurality of recesses are alternatingly offset from each other.

8. The head restraint assembly of claim 5, wherein the columns of the plurality of recesses are alternatingly offset from each other.

9. The head restraint assembly of claim 5, wherein outermost recesses of the plurality of recesses very in width or diameter.

10. The head restraint assembly of claim 5, wherein outermost columns of the rows of the plurality of recesses have a width or diameter along the second axis that is less than a width or diameter of the plurality of recesses that are on an inner side of the outermost columns of the plurality of recesses.

11. The head restraint assembly of claim 5, wherein the plurality of recesses continuously reduce in size from innermost recesses of the plurality of recesses to the outermost recesses of the plurality of recesses.

12. The head restraint assembly of claim 5, wherein each of the plurality of recesses is tapered such that an open end thereof is larger than a closed end thereof.

13. The head restraint assembly of claim 1, further comprising a support core structure around which the head restraint structure is disposed, and stems extending from the support core structure along the third axis.

14. The head restraint assembly of claim 1, wherein each of the plurality of recesses is shaped as a rectangle or a partial rectangle when viewed along the first axis.

15. The head restraint assembly of claim 1, wherein each of the plurality of recesses is shaped as a trapezoid or a partial trapezoid when viewed along the first axis.

16. The head restraint assembly of claim 1, wherein each of the plurality of recesses is shaped as a diamond or a partial diamond when viewed along the first axis.

17. The head restraint assembly of claim 1, wherein each of the plurality of recesses is shaped as an oval or a partial oval when viewed along the first axis.

18. The head restraint assembly of claim 1, wherein the wall portions extend continuously between ends of the cored portion along the third axis in a zigzag pattern.

19. A head restraint assembly of a vehicle seat, the head restraint assembly comprising:
a head restraint structure defining a surface, the head restraint structure comprising:
a main body comprising a foam material comprising polyurethane foam or expanded polypropylene, and
a cored portion comprising the foam material disposed on the surface, the cored portion comprising a plurality of recesses extending into the surface and wall portions extending between the plurality of recesses;
a support core structure around which the head restraint structure is disposed; and
stems extending from the support core structure to a seatback,
wherein the plurality of recesses reduce a firmness of the cored portion to be less than a firmness of the main body,
wherein the main body and the cored portion are formed together of molded foam,
wherein the plurality of recesses are arranged so as to have a plurality of rows of the plurality of recesses and a plurality of columns of the plurality of recesses,
wherein the rows of the plurality of recesses or the columns of the plurality of recesses are alternatingly offset from each other,
wherein outermost rows of the rows of the plurality of recesses and have a width or diameter that vary in width or diameter,
wherein each of the plurality of recesses is tapered such that an open end thereof is larger than a closed end thereof, and
wherein the wall portions extend continuously between ends of the cored portion in a zigzag pattern.

20. A vehicle comprising:
a vehicle seat comprising a seatback and a head restraint assembly extending from the seatback, the head restraint assembly comprising:
a head restraint structure defining a surface and comprising:
a main body comprising a foam material, and
a cored portion comprising the foam material disposed on the surface, the cored portion comprising plurality of recesses extending into the surface and wall portions extending between the plurality of recesses.
